(19) United States
(12) Patent Application Publication
(10) Pub. No.: US 2014/0299552 A1
(43) Pub. Date: Oct. 9, 2014

(54) DISINFECTING WATER USED IN A FRACTURING OPERATION

(71) Applicants: Colin Stewart, Houston, TX (US); Mukesh Kapila, The Woodlands, TX (US); James R. Fajt, College Station, TX (US); Perry Lomond, Houston, TX (US); Daniel Gallo, Fulshear, TX (US); Richard Bingham, Katy, TX (US); Alan McKee, Houston, TX (US)

(72) Inventors: Colin Stewart, Houston, TX (US); Mukesh Kapila, The Woodlands, TX (US); James R. Fajt, College Station, TX (US); Perry Lomond, Houston, TX (US); Daniel Gallo, Fulshear, TX (US); Richard Bingham, Katy, TX (US); Alan McKee, Houston, TX (US)

(73) Assignee: M-I L.L.C., Houston, TX (US)

(21) Appl. No.: 14/119,967

(22) PCT Filed: May 25, 2012
(86) PCT No.: PCT/US12/39736

§ 371 Date: Apr. 21, 2014

Related U.S. Application Data
(60) Provisional application No. 61/491,027, filed on May 27, 2011.
(60) Provisional application No. 61/523,193, filed on Aug. 12, 2011.
(60) Provisional application No. 61/528,991, filed on Aug. 30, 2011.

(51) Int. Cl. C02F 1/467; C02F 1/72; C02F 1/76; C02F 1/78

(52) U.S. Cl. CPC C02F 1/4672; C02F 1/78; C02F 1/722; C02F 1/766; C02F 1/4674; C02F 2103/10
USPC 210/743; 210/758; 210/748.17; 210/748.2; 210/748.19; 210/759; 210/760; 210/739; 210/192; 210/177; 210/143; 210/96.1; 210/97

(57) ABSTRACT

A process for disinfecting a treatment fluid is disclosed, including the step of admixing an aqueous solution comprising two or more oxidants generated via electrolysis of a salt solution with a treatment fluid. The mixed oxidants may be generated on site, using a containerized system.

### FIELD OF THE DISCLOSURE

Embodiments disclosed herein relate to disinfecting wellbore treatment fluids to reduce biological contamination of the fluid prior to placement of the treatment fluid into the wellbore and use of the treatment fluid downhole. More specifically, embodiments disclosed herein relate to disinfecting treatment fluids using a mixed oxidant generated at a well site. Embodiments disclosed herein also relate to disinfecting wellbore treatment fluids to reduce biological contamination of the wellbore and rock formations in contact with the treatment fluid, and the flow back water recovered from the wellbore.

### BACKGROUND

Treatment fluids may be used in a variety of subterranean operations, including, but not limited to, stimulation treatments, damage removal, formation isolation, wellbore cleanout, scale removal, scale control, drilling operations, cementing, conformance treatments, water injection, steam injection, and sand control treatments. Treatment fluids may also be used in a variety of pipeline treatments. As used herein, the term “treatment,” or “treating,” refers to any operation that uses a fluid in conjunction with a desired function and/or for a desired purpose. The term “treatment,” or “treating,” does not imply any particular action by the fluid or any particular component thereof.

One common well production stimulation operation that employs a treatment fluid is hydraulic fracturing. Hydraulic fracturing operations generally involve pumping a treatment fluid (e.g., a fracturing fluid) into a well bore that penetrates a subterranean formation at a sufficient hydraulic pressure to create or enhance one or more cracks, or “fractures,” in the subterranean formation. “Enhancing” one or more fractures in a subterranean formation, as that term is used herein, is defined to include the extension or enlargement of one or more natural or previously created fractures in the subterranean formation. The treatment fluid may comprise particulates, often referred to as “proppant particulates,” that are deposited in the fractures. The proppant particulates, inter alia, may prevent the fractures from fully closing upon the release of hydraulic pressure, forming conductive channels through which fluids may flow to the well bore. The proppant particulates also may be coated with certain types of materials, including resins, tackifying agents, and the like, among other purposes, to enhance conductivity (e.g., fluid flow) through the fractures in which they reside. Once at least one fracture is created and the proppant particulates are substantially in place, the treatment fluid may be “broken” (i.e., the viscosity of the fluid is reduced), and the treatment fluid may be recovered from the formation.

Depending upon the source of the treatment fluid, or portions thereof, the treatment fluid may contain bacteria or other microorganisms that may attack downhole formations (e.g., growing downhole and plugging the formation), may attack polymers and other materials used as proppants, may attack treatment fluids (e.g., affecting fluid properties and performance), or may attack well servicing equipment, including tanks and pipes, for example. In addition to restricting flow, bacteria may also produce unwanted gases downhole. The treatment fluid may contain organic material, either from the source water or from the chemicals and other materials added to the water that constitute a food source for the bacteria or other microorganisms and help promote their growth. The treatment fluid may also contain other chemical components that could be harmful to the performance of the treatment fluid or to the wellbore itself.

A wide variety of biocides have been used in these treatment fluids to control, limit, or eliminate the undesired effect of these microorganisms. For example bactericides may be used to control sulfate-reducing bacteria, slime-forming bacteria, iron-oxidizing bacteria and bacteria that attack polymers in fracture and secondary recovery fluids. Biocides may also include, among others, fungicides, and algaecides.

Biocides are, by their very nature, dangerous to handlers. Handlers must avoid eye and skin contact and, when liquid biocides are utilized, must avoid splashing or spilling the liquid biocide, as spilled biocides can contaminate potable water sources. As a result, regulators are becoming more stringent on the use of harsh biological agents, and on their introduction into the environment, either downhole or on the surface.

### SUMMARY OF THE DISCLOSURE

It has been found that a mixed oxidant produced via electrolysis of a salt solution may be used to effectively disinfect water and other fluids for use in well treatment fluids, including fracturing fluids. These mixed oxidants may provide for a sufficient reduction in undesirable bacteria, spores, fungi, etc. They may also provide a reduction in the organic material that can provide a food source for the bacteria and other microorganisms, and provide a reduction in other harmful components, such as hydrogen sulfide gas. The mixed oxidants are of low or no toxicity and additionally have a short half-life (less than 24 hours, for example) and may degrade rapidly to naturally occurring chemicals following use or contact with the downhole formation, minimizing the environmental impact post-use. Due to the rapid degradation, the sterilization provided by the present invention may be considered virtually chemical free. It has also been found that the mixed oxidants may be provided to a well site using a unique, transportable delivery system as will be described below.

In one aspect, embodiments disclosed herein relate to a process for disinfecting a treatment fluid, the process including the step of admixing an aqueous solution comprising two or more oxidants generated via electrolysis of a salt solution with a treatment fluid.

In another aspect, embodiments disclosed herein relate to a method of servicing a wellbore, the method including: transporting a portable tank containing a quantity of one or more salts to a well site to be serviced; generating a salt solution by passing water through the portable tank to dissolve a portion of the salt; converting the salt solution to an aqueous solution comprising one or more oxidants via electrolysis; contacting the aqueous solution with a treatment fluid to form a treated treatment fluid; and providing the treated treatment fluid for placement into the wellbore.

In another aspect, embodiments disclosed herein relate to a portable system for disinfecting water, including: a fluid connection for connecting to a water supply; a treatment system for conditioning the water supplied; a tank for admixing at least a portion of the conditioned water with one or more salts to form a salt solution; an electrolytic oxidant producing unit for converting at least a portion of the salt solution to an aqueous solution comprising mixed oxidants; optionally one or more tanks for storing the aqueous solution; and a fluid connection for transporting the aqueous solution from the one or more tanks for storing for contact with a fluid to be disinfected. In some embodiments, the system is modular and/or containerized.

In another aspect, embodiments disclosed herein relate to a method of disinfecting a fluid, including: disposing a quantity of one or more salts in a tank; receiving water from a water supply; treating the water received in a water treatment system to form a conditioned water stream; generating a salt solution by passing a first portion of the conditioned water through the tank to dissolve a portion of the one or more salts; combining the salt solution with a second portion of the conditioned water to form a diluted salt solution; feeding the diluted salt solution to an electrolytic oxidant producing unit to convert the salt solution to an aqueous solution comprising one or more oxidants via electrolysis; contacting the aqueous solution with a fluid to form a treated fluid.

In another aspect, embodiments disclosed herein relate to a method for disinfecting a treatment fluid, including: admixing an aqueous solution comprising hypobromous acid generated from a bromide salt solution with a treatment fluid.

In another aspect, embodiments disclosed herein relate to a method for forming a treatment fluid using an ammonia-containing water source, the method including: admixing an aqueous solution comprising hypobromous acid generated from a bromide salt solution to the ammonia-containing water.

In another aspect, embodiments disclosed herein relate to a method for recycling flow-back water from a fracturing operation including: admixing an aqueous solution comprising hypobromous acid generated from a bromide salt solution with the flow-back water; and re-using the flow-back water in a fracturing operation.

In another aspect, embodiments disclosed herein relate to a method recycling flow-back water from a fracturing operation including: storing the flow-back water containing ammonia and a bromide salt in a tank or pond; admixing the flow-back water with an oxidant solution generated by on-site electrolysis of a chloride salt solution; and re-using the flow back water in a fracturing operation.

This summary is provided to introduce a selection of concepts that are further described below in the detailed description. This summary is not intended to identify key or essential features of the claimed subject matter, nor is it intended to be used as an aid in limiting the scope of the claimed subject matter.

Other aspects and advantages will be apparent from the following description and the appended claims.

### BRIEF DESCRIPTION OF DRAWINGS

FIG. 1 is a simplified process flow diagram of a process for disinfecting a treatment fluid according to embodiments disclosed herein.

FIG. 2 is a simplified process flow diagram of a process for disinfecting a treatment fluid according to embodiments disclosed herein.

FIG. 3 is a simplified process flow diagram of a system for generating and delivering a mixed oxidant according to embodiments disclosed herein. In some embodiments, the system is modular and/or containerized, as illustrated by the simplified process flow diagrams for FIG. 4 and FIG. 5, which illustrate one possible manner to contain all of the desired equipment in a transportable module having a relatively small footprint.

FIG. 6 is a simplified process flow diagram of a system for generating and delivering a mixed oxidant according to embodiments disclosed herein.

### DETAILED DESCRIPTION

As used herein, the term “treatment fluid” is meant to include those fluids having oil field applications, such as any number of fluids suitable for pumping downhole to service or treat a wellbore. “Treatment fluid” may thus refer to a fluid used to drill, complete, enhance, work over, fracture, repair, or in any way prepare a wellbore for the recovery of materials residing in a subterranean formation penetrated by the wellbore, including water in ponds and pits, as well as fluids produced during drilling operations, such as flowback water and produced water that may contain residual polymers and dissolved metals in a non-oxidized state, such as Fe, Mn, and S. It is to be understood that “subterranean formation” encompasses both areas below exposed earth and areas below earth covered by water, such as ocean or fresh water. Examples of treatment fluids may include, but are not limited to, cement slurries, drilling fluids or drilling muds, spacer fluids, packer fluids, fracturing fluids, steam or water injection fluids, or completion fluids, all of which are well known in the art. Without limitation, servicing the wellbore includes positioning the treatment fluid in the wellbore to isolate the subterranean formation from a portion of the wellbore; to support a conduit in the wellbore; to plug a void or crack in the conduit; to plug a void or crack in a cement sheath disposed in an annulus of the wellbore; to plug an opening between the cement sheath and the conduit; to prevent the loss of aqueous or non-aqueous drilling fluids into loss circulation zones such as a void, vugular zone, or fracture; to be used as a fluid in front of cement slurry in cementing operations; to seal an annulus between the wellbore and an expandable pipe or pipe string; to fracture a formation; to flood a formation to improve hydrocarbon recovery, to work over the wellbore to remove scale, bacteria or other accumulations or blockages; or combinations thereof.

In one aspect, embodiments disclosed herein relate to disinfecting wellbore treatment fluids to reduce biological contamination of the fluid prior to placement of the treatment fluid into the wellbore and use of the treatment fluid downhole. More specifically, embodiments disclosed herein relate to disinfecting treatment fluids using a mixed oxidant generated at a well site.

Any number of the treatment fluids noted above may be formed using water or other fluids contaminated with various microorganisms, including sulfate-reducing bacteria, slime-forming bacteria, iron-oxidizing bacteria and/or bacteria that attack polymers in fracture and secondary recovery fluids, as well as fungi and/or algae and organic food sources or other components that can be treated by this invention. Prior to use of the contaminated fluids to form the desired treatment fluids, or concurrent with the formation of the treatment fluids with the contaminated fluid, it is desirable to disinfect the water or treatment fluid to minimize the impact the microorganisms may have on drilling, completion, fracturing, and/or production.

It has been found that a mixed oxidant may be used to control the growth of the microorganisms. The mixed oxidant may be generated in some embodiments by the electrolysis of a brine or salt solution, such as a solution of one or more salts in water. The one or more salts may include at least one of an alkali metal halide, an alkaline earth metal halide, and a transition metal halide, where the halide may include fluorine, chlorine, bromine, or iodine, for example. In particular embodiments, the salt may be sodium chloride, sodium bromide, potassium bromide or a mixture including sodium chloride, sodium bromide, or potassium bromide, among others. Electrolysis of the salt solution may produce a mixture of oxidants, including two or more of ozone, hydrogen peroxide, hypohalite (e.g., hypochlorite), hypohalous acid (e.g., hypochlorous acid or hypobromous acid), halogen oxides (e.g., chlorine dioxide, bromine dioxide), and halogen (e.g., chlorine, bromine), and other halo-oxygen (e.g., chlor-oxygen) species, for example. However, it should be understood that the term “mixed oxidant” as used herein may also include a solution of only one oxidant except where defined otherwise.

The combination of oxidants and halide salts in a water-based solution, produced via electrolysis of a salt solution, may enhance the potential of the disinfecting formulation and create an unexpected synergistic effect for substantially increasing rates of disinfection as compared to oxidants, such as ozone, utilized alone. In some embodiments, for example, the mixed oxidant system may result in a reduction of bacterial concentration in water by a 6 log reduction or more. The reduction in bacteria concentration may be realized by contacting the fluid to be treated with the aqueous solution comprising the mixed oxidants for a time period of up to about 2 weeks, such as in the range from about 1 second to about 2 hours in some embodiments; in the range from about 1 minute to about 30 minutes in other embodiments; and in the range from about 2 minutes to about 10 minutes, such as about 5 minutes, in yet other embodiments.

In addition to treatment fluids mentioned above, a mixed oxidant generated according to embodiments disclosed herein may also be useful for treating other oilfield waters, such as tanks, ponds, recycled waters, discharged waters, flow back waters, and recycling of water used in steam injection. The treatment may be used for all fresh or recycled water (flow back, produced, water from drilling fluids, in frac tanks, water produced during air drilling, stagnant ponds, etc.), water and steam injection (enhanced recovery), packer fluids, oilfield pipelines, disposal wells, workovers, production (replace biocides, remove slime), and other applications in the downstream areas.

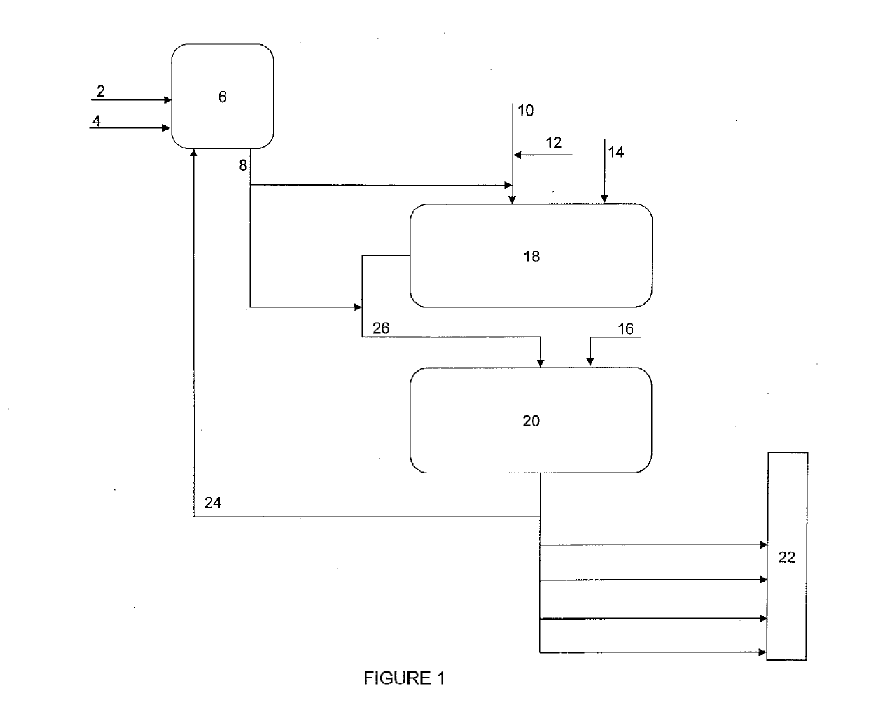

Referring now to FIG. 1, a simplified flow diagram of a process for contacting a mixed oxidant with a treatment fluid according to embodiments disclosed herein is illustrated. Water 2 and one or more salts 4 are admixed to form a salt solution, which then undergoes electrolysis in mixed oxidant generating system 6, which includes an electrolytic oxidant producing unit (not shown), to form an aqueous solution comprising mixed oxidants 8.

A treatment fluid may be formed by admixing a base fluid 10 with one or more additives 12, 14, 16 in one or more mixing devices or tanks 18, 20. For example, a base fluid 10, such as water or brine, may be mixed with proppants, weighting agents, or other additives 12, 14, 16, in a precision continuous mixer (PCM) 18 and a programmable optimum density blender (POD) 20 to form a treatment fluid.

The fluid to be treated may be contacted with mixed oxidant solution 8 to disinfect the treatment fluid prior to placement of the treatment fluid into the wellbore 22, such as at varying positions along the length of the missile. Contact of the treatment fluid with the mixed oxidant may be initiated in the mixers, blenders, pumps, or associated piping, and may be initiated at one or more locations so as to provide a sufficient residence time for obtaining the desired reduction in biological contamination. For example, as illustrated, a first portion of the mixed oxidant solution may be combined with the treatment fluid upstream of PCM 18, and a second portion of the mixed oxidant solution may be combined with the treatment fluid upstream of POD 20, prior to delivery of the disinfected fluid downhole to missile 22.

The effectiveness of the mixed oxidant treatment may be monitored or controlled using one or more analyzers to measure or determine residual halogen content, such as free available chlorine (FAC) or free available bromine (FAB), residual oxidant content, oxidation reduction potential (ORP), pH, microorganism concentrations, or other relevant indicators known to one skilled in the art. For example, for a mixed oxidant produced using chlorine salts, a sample of the treated fluid may be analyzed for residual chlorine content, which may provide a measure of the effectiveness of the biological reduction as well as an indication as to the excess or shortage of the dosage provided. A residual chlorine content of about 2 ppm, for example, may indicate that the treatment fluid has been sufficiently disinfected. Higher residuals may also be targeted to ensure that the treatment water has been sufficiently disinfected and/or to ensure that little or no bacteria is present in the flowback water. Higher residuals may also be targeted to provide some treatment capacity for the fluid flowing downhole, which may aid in the treatment, removal and/or prevention of biofilm buildup and other biological contamination of one or more of the mixing tanks 18, 20, associated piping, the wellbore, and rock formations that come into contact with the treatment fluid during the treatment process.

As illustrated and by way of example only, a sample of the treated treatment fluid may be obtained via flow line 24 and analyzed for residual oxidant levels via measurement of oxidation reduction potential (ORP) using an appropriate analyzer (not shown), which may be located in mixed oxidant generating system 6 (feed back control loop). Samples may additionally or alternatively be obtained from the PCM 18, the POD 20, or the transfer line 26 between the PCM and POD (feed back control). If desired, a sample of the fluid to be treated may be taken from flow line 10 upstream of PCM 18 (feed forward control loop). A combination of feed back and feed forward control may also be used. The volumetric ratio of mixed oxidant solution to treatment fluid (dosage ratio) may then be adjusted or controlled based upon the analyses from the various samples. Additionally or alternatively, the point of contact or a throughput rate may be adjusted or controlled to vary the contact time provided before use of the treated fluid downhole.

As another example, the effectiveness of the mixed oxidant treatment may be monitored or controlled using one or more sample points measuring free available chlorine and oxidative reduction potential. Due to chemical species that may be present in the water used to generate the treatment fluid or in the chemicals and additives added to the water, contact with the mixed oxidant solution may result in reactions that form chemical species that may mask the actual effect achieved. For example, ammonia may react with hypochlorous acid to form monochloramines (NH₂Cl), dichloramines (NHCl₂), and trichloramines (NCl₃), which may be detected when measuring residual chlorine levels, but may be accounted for by additionally measuring oxidative reduction potential. Thus, in some embodiments, use of multiple analytical techniques may provide an indication of the true effectiveness of the mixed oxidant treatment, enhancing the control of the mixed oxidant treatment (dosage rates, etc.). Real time or near real time measurement of ORP, FAC, pH or other properties of the treated treatment fluid may thus provide for fully integrated control of the system to ensure disinfection dose rates are suitable to achieved the desired disinfection, and may allow for optimal dosage rates to be used, preventing under dosing or excess dosing of the treatment fluid with the mixed oxidants.

Depending upon the concentration of salt in the salt solution and the electrolysis results, the mixed oxidant solution may contain 100 ppm to 10,000 ppm oxidants, such as about 2000 ppm to about 8000 ppm oxidants in some embodiments, or from about 3000 ppm to about 6000 ppm oxidants in other embodiments, such as about 4000 ppm to about 5000 ppm (by weight). To achieve the desired reduction in biological microorganisms, the mixed oxidant solution may be used in some embodiments at a volume ratio in the range from about 1 gallon mixed oxidant solution per 10 barrels treatment fluid to about 1 gallon mixed oxidant solution per 500 barrels treatment fluid (1 gallon: 10 barrels to 1 gallon: 500 barrels). In other embodiments, the volume ration may be in the range from about 1 gallon to 20 barrels to about 1 gallon to 100 barrels; from about 1 gallon to 30 barrels to about 1 gallon to 50 barrels in yet other embodiments.

Electrolysis of the salt solution may be performed using an electrolytic oxidant producing unit. Such units are disclosed or referenced in, for example, U.S. Pat. Nos. 7,922,890, 5,853,579, 7,429,556, and 6,524,475, among others. Electrolytic oxidant producing units are available from MIOX Corporation (Albuquerque, N.Mex.), for example.

The electrolytic oxidant producing units may be sensitive to various metals and other components that may be present in the water supplied via flow line 2. One of the major failure mechanisms of undivided electrolytic cells is the buildup of unwanted films and scaling on the surfaces of the electrodes. The source of these contaminants is typically either from the feed water to the on-site generation process or contaminants in the salt(s) that is (are) used to produce the brine solution feeding the electrolytic system. As such, it may be desirable or necessary to treat the water supplied via flow line 2 to reduce, regulate, or control the total dissolved solids (TDS) of the water to be less than about 5000 mg/L in some embodiments; less than about 3000 mg/L in other embodiments; and less than about 1000 mg/L in yet other embodiments. To minimize unwanted contaminants, the water fed to the system may be processed through one or more filtration systems and/or a water softening system. Further, the quality of the salt provided may be specified to minimize the incidence of electrolytic cell cleaning operations.

Operation of the electrolytic cells may also be sensitive to the temperature and pressure of the salt solution. As native water supplies (streams, rivers, lakes, etc.) and other water supplies (wells, public water supply, etc.) may be provided at varying temperatures and pressures, it may be necessary to boost or reduce the supply pressure and/or to increase or reduce the temperature of the water or salt solution. In some embodiments, the temperature of the water supplied may be adjusted to be within the range from about 45° F. to about 100° F.; in the range from about 50° F. to about 90° F. in other embodiments; and in the range from about 55° F. to about 80° F. in yet other embodiments. In some embodiments, the pressure of the water supplied may be adjusted to be within the range from about 20 to about 200 psig; in the range from about 40 to about 150 psig in other embodiments; and in the range from about 60 to about 110 psig in yet other embodiments. Depending upon the design of the electrolytic cells, other temperatures and pressures may also be used.

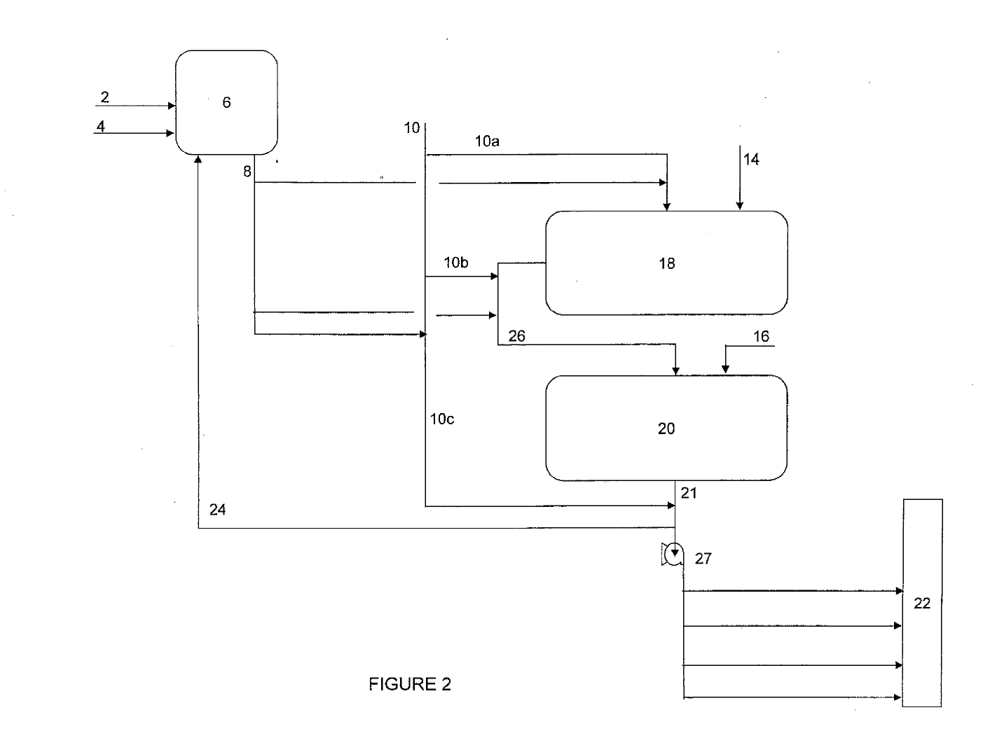

Referring now to FIG. 2, a simplified flow diagram of a process for contacting a mixed oxidant with a treatment fluid according to embodiments disclosed herein is illustrated, where like numerals represent like parts. Water 2 and one or more salts 4 are admixed to form a salt solution, which then undergoes electrolysis in mixed oxidant generating system 6, which includes an electrolytic oxidant producing unit (not shown), to form an aqueous solution comprising mixed oxidants 8.

In this embodiment, the treatment fluid may be formed by admixing one or more portions (a, b, c) of a base fluid 10 with one or more additives 14, 16 in one or more mixing devices or tanks 18, 20, with the admixture being combined with additional base fluid for pumping of the treatment fluid downhole (i.e., a split line frac system, limiting the overall amount of base fluid being pumped through mixing vessels). For example, a first portion 10a of base fluid 10, such as water or brine, may be mixed with proppants, weighting agents, or other additives 14, 16, in a precision continuous mixer (PCM) 18 and a programmable optimum density blender (POD) 20 to form a treatment fluid 21. If desired, a second portion 10b may be added to the POD 20.

The mixed oxidant solution 8 may be contacted with the treatment fluid 21, or a treatment fluid precursor, such as base fluid 10 or a portion thereof or an admixture within or an effluent from PCM 18 or POD 20, to disinfect the treatment fluid prior to placement of the treatment fluid into the wellbore 22, such as at varying positions along the length of the missile. Contact of the treatment fluid with the mixed oxidant may be initiated in the mixers, blenders, pumps, or associated piping, and may be initiated at one or more locations so as to provide a sufficient residence time for obtaining the desired reduction in biological contamination. For example, as illustrated, a first portion of the mixed oxidant solution may be combined with the base fluid portion 10a upstream of PCM 18, a second portion of the mixed oxidant solution may be combined with the effluent from PCM 18 upstream of POD 20, and a third portion of the mixed oxidant may be contacted with the remaining base fluid portion 10c prior to delivery of the disinfected fluid downhole to missile 22 via high pressure pump 27. A sample of the treated treatment fluid may be obtained via flow line 24 upstream of pump 27 (i.e., on the low pressure side of the pump) for analyses as described above, including one or more of residual oxidant content, a pH, a free available halogen content, and an oxidation reduction potential, among others.

Control of the flow of mixed oxidant may be based on the specific needs of the various streams. For example, the bulk of the base fluid may be contained in portion 10c, which may require more or less oxidation, depending upon the supply. In contrast, the lower flow of base fluid through PCM 18 and POD 20 may require less treatment (lower base fluid flow) or possibly more treatment (possibly due to chemical injection/additive mixing or stagnant areas within the mixing tanks and associated piping, if any, allowing for growth of biological contaminants). The multiple injection points for the mixed oxidant solution may thus be controlled to meet the specific needs of the particular mixing system and additives used, resulting in a properly treated fluid injected downhole.

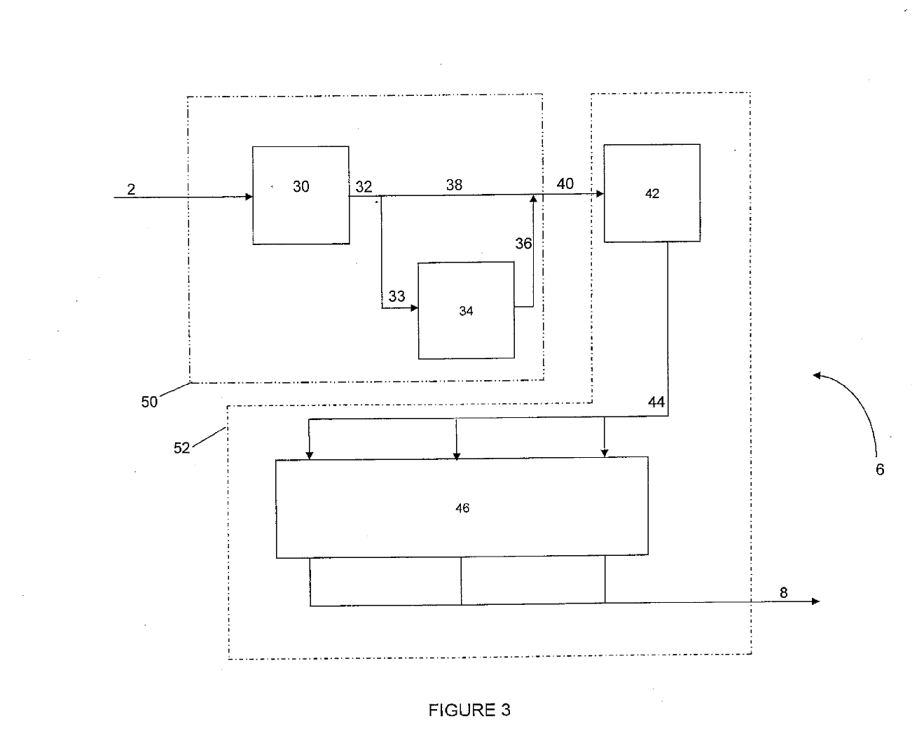

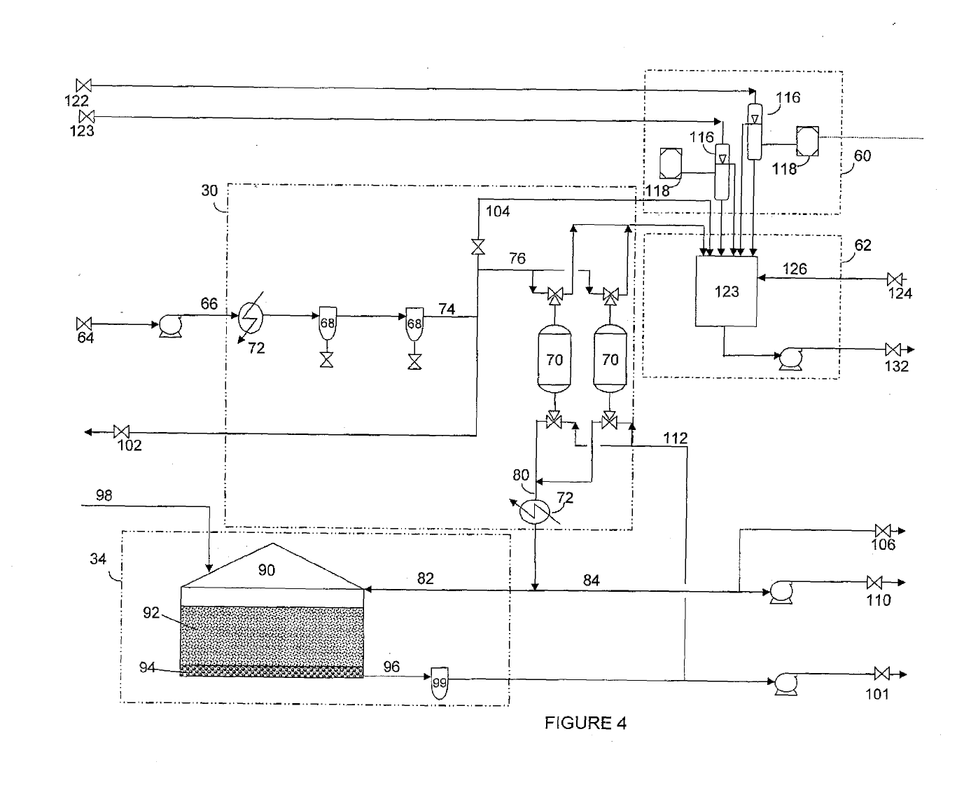

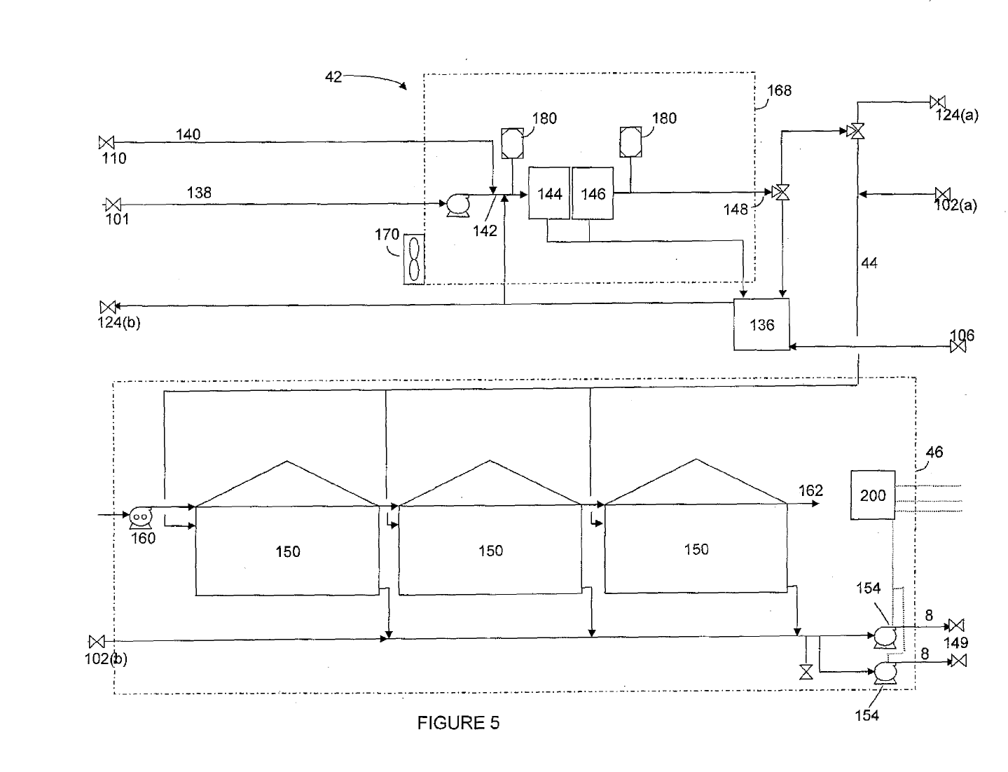

Referring now to FIG. 3, a simplified process flow diagram of a mixed oxidant generating system 6 according to embodiments disclosed herein is illustrated, where like numerals represent like parts. Pumps, flow control valves, pressure control valves, block valves, and other related equipment are not illustrated for simplicity of illustration. Water may be supplied via flow line 2 and fed to a water treatment system 30. In water treatment system 30, the water may be filtered, softened, and heat exchanged to result in a conditioned water stream 32 having a desired temperature and TDS content.

A first portion 33 of the conditioned water may then be combined with one or more salts 4 in salt solution generation system 34. For example, a quantity of salt may be disposed in a tank, and the salt solution may be generated by passing the first portion of the conditioned water through the tank to dissolve a portion of the salt. The resulting salt solution, recovered via flow line 36, will be saturated or close to saturated with salt.

The salt solution 36 may then be combined with a second portion 38 of the conditioned water to form a diluted salt solution 40 for feed to an electrolytic oxidant producing unit 42. The diluted salt solution should be at the desired feed temperature, such as between about 55° F. and 80° F., and may have a dissolved salt content in the range from about 0.01% to 5% by weight, such as in the range from about 0.1% to about 3% by weight. Electrolysis of the dissolved salt solution in electrolytic oxidant producing unit 42 may result in various oxidant compounds, including ozone, hydrogen peroxide, hypohalite (e.g., hypochlorite), hypohalous acid (e.g., hypochlorous acid), halogen oxides (e.g., chlorine dioxide), and halogen (e.g., chlorine), and other halo-oxygen (e.g., chlor-oxygen) species, for example. The mixed oxidant solution may then be recovered from unit 42 via flow line 44 and fed, optionally to one or more storage vessels 46, via flow line 8 for contact with a fluid to be disinfected. Electrolytic cells useful in electrolytic oxidant producing unit 42 may vary in size/capacity, and some embodiments of systems disclosed herein may include two or more electrolytic oxidant producing units 42.

Disinfection of the treatment fluids may not be desired during the entire drilling process, and may only be desired, for example, during fracturing of a well with a fracturing fluid. In such instances, it would be desirable to have a mixed oxidant delivery system arrive at the drill site for only the time needed to disinfect the treatment fluid during the desired drill site operation.

To facilitate the temporary need at a drill site, the mixed oxidant generating system may be transportable in some embodiments disclosed herein, where the mixed oxidant system may be containerized and may be modular using two or more containerized modules. In some embodiments, the mixed oxidant generating system may be contained within one module that is no greater in size than one forty-foot equivalent unit (FEU). In other embodiments, the mixed oxidant generating system may be contained within two modules, where the first and second modules are no greater in size than one FEU. In yet other embodiments the mixed oxidant generating system may be contained within two modules, where the first module is no greater in size than one twenty-foot equivalent unit (TEU), and the second module is no greater in size than two TEU. As used herein, one FEU is defined as being similar in size to that of a typical transport container 40 feet long by 8 feet wide by 9.5 feet tall (12.2 m×2.4 m×2.9 m) (approximately 3040 cu ft or 87 m³), and one TEU is defined as being similar in size to that of a typical transport container 20 feet long by 8 feet wide by 9.5 feet tall (6.1 m×2.4 m×2.9 m) (approximately 1520 cu ft or 43 m³). For example, as illustrated in FIG. 3, a first module 50 may contain water treatment system 30 and salt solution generation system 34, among other components (not illustrated), and a second module 52 may contain the electrolytic oxidant producing unit 42 and one or more mixed oxidant storage tanks 46. In this manner, the system for generating and delivering a mixed oxidant may be modular, containerized, easy to transport, and easy to set up at or remove from the well site. For example, to facilitate setup at the drill site, the modular system may be outfitted with fluid connections to quickly connect water supply line 2 to a water supply, to connect mixed oxidant stream 8 to fluid conduits for transporting the mixed oxidant for admixture with the treatment fluid, and to connect various lines between the modules 50, 52, including rinse lines, process returns lines, and other lines not shown.

Drill sites may be space constrained, and delivery or storage of chemicals may not always be possible or even desired due to potential for spillage and other handling issues. For example, delivery, storage, and handling of biocides at a drill site is generally not desirable, but is often tolerated for the short duration of a fracturing operation.

To avoid or minimize the handling of salts and other components, transportable systems for generating a mixed oxidant according to embodiments disclosed herein may arrive at the drill site containing all necessary components and chemicals, including salts for forming the salt solution and acid or other compounds used for cleaning the electrolytic cells. For example, salt solution generating system 34 may include a tank (not shown). A quantity of salt may be disposed in the tank at a remote location. The tank may then be transported to the drill site to be serviced and used to generate a salt solution by passing water through the transported tank. Similarly, an acid storage tank may be provided in the module(s) for containing acid to be used for cleaning the electrolytic cells. In this manner, the salts and acids do not have to be shipped separately to the drill site and loaded into the tanks, thereby minimizing the need for delivery, storage, and handling of these compounds at the drill site, and simultaneously minimizing possible spillage and exposure.

FIGS. 4 and 5 illustrate simplified process flow diagrams for one possible embodiment of modules 50 and 52, respectively, where like numerals represent like parts. As shown, the equipment in module 50 may be arranged and sized to fit in one TEU, and the equipment in module 52 may be arranged and sized to fit in one FEU.

Referring now to FIG. 4, module 50 may include a water treatment system 30, a salt solution generating system 34, a sampling system 60, and a process returns treatment system 62. As described above, water connection 64 may be connected to a water supply at the drill site. The water may then be pumped via conduit 66 to water treatment system 30, which may include one or more filtration systems 68, and one or more water softening systems 70. Filtration system 68 may include bag filters, cartridge filters, and the like. Water treatment system 30 may also include one or more heat exchangers 72, the location of which may depend upon whether it is desired to heat or cool the water before, intermediate, or after filtration and softening.

The water in conduit 66 passes through the one or more filters 68 to result in a filtered water stream 74, a portion of which is fed via flow line 76 to water softening systems 70. Conditioned water (i.e., filtered and softened, and optionally heated/cooled) may be recovered via flow line 80. A first portion of the conditioned water may then be forwarded to salt solution generation system 34 via flow line 82, and a second portion of the conditioned water may be recovered via flow stream 84.

Salt solution generating system 34 may include one or more tanks 90 that may be loaded with a quantity of one or more salts 92 over top of a bed of granular material that prevents the salt from flowing as a solid into conduit 96. As noted above, the salt may be loaded at the drill site or may be pre-loaded at a remote location, such as via an inlet 98 located on an upper portion of the tank 90. The conditioned water may be passed through the tank, dissolving a portion of the salt, and a salt solution may be recovered via flow line 96. Filter 99 may be provided to protect downstream equipment from any solids that may happen to pass out of tank 90. The salt solution is then pressurized and pumped to connection 101.

As illustrated, the filtered water in conduit 74 is divided into three fractions, fraction 76 being described above. Additionally, a portion of the filtered water may be used occasionally during routine operation of the system or for cleaning of the system, and may be routed to rinse water connection 102, or may be fed via flow line 104 to purge the process returns treatment system 62. Conditioned water stream 84 may similarly serve as a softened water rinse supply, being fed to softened water rinse connection 106. Conditioned water stream 84 is also fed to a booster pump 108 for feed to boost water connection 110.

Water softening system 70 may require periodic regeneration, which may be performed using the salt solution generated in system 34. During regeneration of the softening system 70, a portion of the salt solution in conduit 96 is routed via flow line 112 to water softening system 70. The discharge is then fed via flow line 114 to process returns system 62.

Sampling system 60 may include one or more sample valves/diverters 116, each associated with one or more analyzers 118 for measuring residual chlorine content, conductivity, or other properties of the treatment fluid following contact with the mixed oxidant solution. The samples may be transported from various points in the drilling or completion system, routed to module 50 via connections 120, 122.

Process returns treatment system 62 may include a storage tank 123 to accumulate materials from various streams and vessels during operation of the system, including process returns generated during startup of the electrolysis unit, sampling, water softening agent regeneration, and cleaning of the electrolytic cells (described below for FIG. 5), among others. Process returns from cleaning of the electrolytic cells may be routed to module 50 via connection 124 and conduit 126, for example.

The fluids accumulated in storage tank 123 may include water, treatment fluid samples, discharge from regeneration, and spent acid from electrolytic cell cleaning. As acid cleaning is only performed when needed, it may not be necessary to clean the cells at each well site or even during the disinfecting process. The process returns fluids generated during the operation of the mixed oxidant generation system may thus be fed via conduit 130 to connection 132 for fluid communication to other well site processes or storage tanks. For example, the process returns fluids or a portion thereof may be used to form at least a portion of the treatment fluid. In this manner, the process returns are effectively used to form a product, and all liquid “process returns” generated from the system may be consumed during other well site operations, resulting in negligible waste production as a result of the disinfecting process (other than solid wastes collected, such as filter cartridges, etc.).

Referring now to FIG. 5, module 52 may include salt solution storage system 46, electrolytic oxidant producing unit 42, and acid wash system 136. Salt solution provided via connection 101 and conduit 138 and boost water provided via connection 110 and conduit 140 are fed to the electrolytic oxidant producing unit 42. The flow rates and pressure of the boost water and salt solution are controlled such that a diluted salt solution 142 is provided to the electrolytic cells in chambers 144, 146, producing an effluent comprising a mixed oxidant recovered via flow line 148. The mixed oxidant is then fed, optionally via flow line 44 to mixed oxidant storage system 46 when storage is provided and/or desired, via flow lines 8 to connections 149 for fluid transport of the mixed oxidant solution for contact with the treatment fluid.

Mixed oxidant storage system 46 may include one or more vessels 150, each having a size of at least 500 gallons. For example, as illustrated, module 52 may include three storage vessels 150 each holding approximately 800 gallons, for a total reserve volume of about 2400 gallons.

The mixed oxidant produced in electrolytic oxidant producing unit 42 is stable for a period of about 24 hours. As such, it is not desirable to produce mixed oxidant solution until needed. The vessels 150, when used, may provide a buffer for storage of mixed oxidant solution in the event of a power failure, such as where the power to electrolytic oxidant producing unit 42 is inadvertently or temporarily cut off. As it is desired to continue feed of the mixed oxidant solution for the disinfecting process, even in the event of a power loss to the remainder of the system, module 52 may also be provided with a power generator (not shown) to operate pumps 154 and the associated control valves, so as to maintain continuity of the disinfecting during the fracturing operation.

A byproduct of electrolytic oxidant producing unit 42 is hydrogen, which may accumulate in vessels 150. To prevent excessive accumulation of hydrogen, and to maintain the hydrogen concentration well below flammability or explosion limits, a blower 160 may circulate air or nitrogen through the head space of vessels 150, venting a hydrogen-containing vapor stream via flow line 162, which may then be vented to the atmosphere, fed to a flare, or otherwise disposed of safely. Alternatively, a degassing column (not shown) may be used upstream of the vessels 150 to separate hydrogen.

As noted above, it may be necessary to periodically clean the electrolytic cells due to film formation on the electrodes. Acid wash system 136 may include a tank containing an acid suitable to clean the electrodes, such as muriatic acid or hydrochloric acid. The acid may then be diluted with rinse water, if necessary, and circulated through chambers 144, 146 to clean the electrodes. The process returns generated during the cleaning operation may then be routed to the process returns tank 123, or may alternatively be managed as an individual process returns stream. Cleaning operations and routine operation of the unit may be monitored, for example, using one or more analyzers 180. In some embodiments, the cleaning step may be performed using acid generated on site using an acid generating electrolytic cell, such as described in U.S. Pat. No. 7,922,890, for example.

Cleaning water for flushing or purging components in module 52 may be supplied as described for FIG. 4, where module 52 includes connections for mating with the flow line connections in module 50. These are similarly labeled in FIG. 5, with an (a) or (b) indicating that the flow may be split to different units following the mating connection between the two modules.

A significant amount of particulates (sand, dust) may be present in the air at the drill site, especially during fracturing operations due to transport of the proppant. To prevent damage to electrolytic oxidant producing unit 42, the unit may be located in an enclosure 168 having a filtered air cooling system 170, thus providing for circulation of filtered air through the enclosure, removing heat generated or given off during the electrolysis process and protecting the equipment from exposure to conditions normally encountered at a well site during fracturing operations.

When the modular system arrives at a well site, the system may be set up and operational in a matter of hours (such as less than 8 hours). Connections must be made for fluid communication between the modules (connections 102, 106, 124, where each may be split in the modules into one or more fractions (a), (b)), for fluid communication with a water supply (connection 64), for transport of the boost water and salt solution to the electrolytic oxidant producing unit 42 (connections 101, 110), and for transport of the mixed oxidant solution via one or more flow lines 8 (connections 149). The remaining needs of the system are a power supply for the electrolytic cells, and communication conduits (hard or wireless) for communicating the treatment fluid flow rate, compositions, analyses, time to completion, time to start, and/or other information and process data to a control system 200, where the control system is configured to use the communicated information to control or adjust the flow rate of the mixed oxidant solution for contact with the treatment fluid based on the analyses and measured flow rates, among other possible variables. In this manner, the control system for the mixed oxidant systems disclosed herein may communicate with internal and/or external sources to control the supply of mixed oxidant solution to the treatment fluid.

For example, the external control system of fracturing operation may communicate the flow rate of a fracturing fluid or one or more components of a fracturing fluid to a well so that dosage of mixed oxidant solution added may be controlled to match the changes in the flow rate and/or composition through the cycles of a fracturing operation. As another example, the communication may provide an indication of when to start or stop feeding of the aqueous solution, such as for when fracturing operations are to be concluded or to avoid mixing of the aqueous solution during an acid spear, commonly used at the beginning of a fracturing operation, or when other potentially incompatible fracturing fluid additives may be used. As yet another example, the communication may provide an indication of a property or composition of the fluid to be disinfected, so as to properly adjust a flow rate of the mixed oxidant, such as when a treatment fluid additive type or relative amount of a treatment fluid additive is changed.

As a specific control example, it may be common during a fracturing operation to change from an acrylamide based polymeric additive to guar. Communications may be received by the control system indicating that the composition of the polymeric additive is changing, and the control system may then adjust the flow rate of the mixed oxidant to account for an increase in oxidant demand due to the change in additives. Similarly, fracturing operations may switch from a non-coated proppant to a resin coated proppant, resulting in an increase in mixed oxidant demand. Further, when live breakers (e.g., non-encapsulated ammonium persulfate) are used, it may be desirable to decrease mixed oxidant feed rates to avoid potential reactions that may affect performance of breaker.

By further example, embodiments of the control process may include one or more of the steps of: (a) Receiving a signal indicating the flow rate of one or more components of a treatment fluid. The flow rate signals may be volumetric, mass, or weight flow rates and may provide the identity of the component. The signal may be provided by the external control system of a fracturing operation, and the signal may be received by the control system. (b) Calculating a flow rate (also referred to as a dose rate) of the aqueous solution comprising oxidants from the component flow rate based on a predetermined oxidant demand per volumetric, mass, or weight unit of the component. (c) Selecting the predetermined oxidant demand for the dosing rate calculation when the signal indicates the component corresponding to the demand is present in treatment fluid from a group of oxidant demands stored in the control system. (d) Calculating an aggregate dose rate of the aqueous solution based on the sum of the calculated dose rates for two or more components of the treatment fluid. (e) Admixing the aqueous solution to the treatment fluid at or in response to the calculated dose rate or aggregate dose rate. (f) Using the calculated dose rate (or aggregate dose rate) as the rate of admixing of the aqueous solution to the treatment fluid for a predetermined period of time, and then controlling, based on a signal indicating at least one of a residual oxidant content, a pH, a free available halogen content, and an oxidation reduction potential of the treated fluid. This may be done during the initial stages of a fracturing operation, e.g. until the operator has confidence that residual oxidant levels in the treatment fluid are relatively steady. (g) Using the calculated dose rate (or aggregate dose rate) as the rate of admixing of the aqueous solution to the treatment fluid until a signal indicating at least one of a residual oxidant content, a pH, a free available halogen content, and an oxidation reduction potential of the treated fluid is not changing at more than a pre-set rate (i.e. is steady). (h) Switching from the rate of admixing controlling based on a signal indicating at least one of a residual oxidant content, a pH, a free available halogen content, and an oxidation reduction potential of the treated fluid to using the calculated dose rate as set point for the rate of admixing during an ongoing fracturing operation when the calculated dose rate changes for a predetermined period of time or until at least one of a residual oxidant content, a pH, a free available halogen content, and an oxidation reduction potential of the treated fluid is steady. (i) Increasing the dose rate of the aqueous solution in response to the signal indicating the composition of the treatment fluid changing during a fracturing operation such that flow rate of an acrylamide-based polymeric additive decreases and the flow rate of a guar additive increases. (j) Decreasing the dose rate of the aqueous solution in response to the signal indicating the composition of the treatment fluid changing during a fracturing operation such that flow rate of a guar additive decreases and the flow rate of an acrylamide-based polymeric additive increases. (k) Increasing the dose rate of the aqueous solution in response to the signal indicating the composition of the treatment fluid changing during a fracturing operation such that flow rate of non-coated proppant decreases and the flow rate of resin coated proppant increases. (l) Decreasing the dose rate of the aqueous solution in response to the signal indicating the composition of the treatment fluid changing during a fracturing operation such that flow rate of resin coated proppant decreases and the flow rate of non-coated proppant increases. (m) Decreasing the dose rate of the aqueous solution in response to the signal indicating the composition of the treatment fluid during a fracturing operation changing such that the flow rate of a live breaker increases.

Thus, embodiments of control systems herein may be configured to determine a mixed oxidant demand, as well as control or adjust a flow rate of the mixed oxidant, based on information provided by the local or remote communications conduits. Such control may include feedback control, such as based on sample analyses or on-line measurement of residual halogen content or ORP, feedforward control, such as based on flow rates, compositional analyses or other information that may be provided with respect to the treatment fluid upstream from the mixed oxidant injection location(s).

Control systems herein may also be configured to generate a treatment report that can be provided to the operator of the drilling operations. The report may include process operations history, presented in the form of charts, graphs, or raw data, for example, to summarize the performance of the disinfecting process during the fracturing operation. For example, data may include mixed oxidant type, mixed oxidant flow rates, measured ORP, measured pH, measured residual free available or total halogen concentration or other oxidant concentration, and other data available from the control system for monitoring and operating the disinfecting process. In some embodiments, the control system may be configured to integrate disinfecting process operations data with information received from the remote source, such as fracturing fluid additive types, compositions, flow rates, etc., so as to provide an integrated or overall operations report, inclusive of data related to the treatment fluid or fracturing fluid provided by the remote communications.

In other embodiments, the control system for the mixed oxidant systems disclosed herein may rely on the sample analyses to control the process, such as where external communications are not available. Containerized modules may include such communication conduits, and control systems of containerized or non-containerized processes disclosed herein may be configured to operate in the presence or absence of such communications, thus providing flexibility to meet the needs of the various wellsites, regardless of their communication capabilities, that may be treated with mixed oxidants produced by the systems disclosed herein. Systems disclosed herein may also include hardware and/or software to provide for transmitting and receiving communications to and from the control system, such as wired or wireless communications from a phone, computer, or satellite, to allow remote monitoring, diagnostics, and/or control of system operations, for example.

As shown in FIG. 5, the containerized system may include one electrolytic oxidant producing unit 42. While flow of fracturing or other treatment fluids at the well site may vary or be intermittent, it is preferred to operate the electrolytic oxidant producing unit 42 continuously when needed. Appropriate sizing of the electrolytic oxidant producing unit 42 and the buffer tanks 150 is thus important. For example, it may be anticipated that treatment fluid flow rates may vary from 0 barrels per minute to 120 barrels per minute or more during fracturing operations. Depending upon the water quality at the well site, at peak fracturing fluid flow rates, mixed oxidant solution flow rates may be on the order of 15 to 30 gallons per minute. In such a scenario, a mixed oxidant producing unit 42 that produces about 20 gallons per minute, and three buffer tanks 150 each holding about 800 gallons could be sufficient to meet the need for disinfecting fluid at the well site throughout the fracturing operation, the buffer tank volume varying significantly due to the intermittent flow of treatment fluid. If desired, however, two or more electrolytic mixed oxidant producing units 42 of the same or different capacity may be connected in parallel to provide the desired mixed oxidant supply rate. These units may be housed within a common enclosure 168, or in a separate enclosure 168 located on the same or different modules.

The mixed oxidant solutions discussed herein may include hypobromous acid as an oxidant. In some cases, such as when disinfecting a water source containing ammonia, for example, hypobromous acid may be more effective than other oxidants, such as hypochlorous acid, possibly due to the stability of the mono halo amines, monochloramine being more stable than monobromamine. For example, fracturing operation operations often used chemicals that generate ammonia as a by-product, such as glutaraldehyde, or contain ammonium salts such as ammonium persulfate, ammonium bisulfite. Hypochlorous acid in the presence of ammonia or ammonium salts may react to form chloramines, which are regarded as a poor disinfectant with less than 5% of the effectiveness of hypochlorous acid. Hypobromous acid in the presence of ammonia reacts to form bromamines, which are considered to be almost equally effective disinfectant to hypobromous acid, and only slightly less effective than hypochlorous acid.

Methods for disinfecting a treatment fluid according to embodiments disclosed herein may include admixing a mixed oxidant aqueous solution comprising hypobromous acid generated from a bromide salt solution with a treatment fluid. In one embodiment, the hypobromous acid may be generated by feeding a bromide salt solution to an electrolytic oxidant producing unit. Optionally, the bromide salt solution may be fed to the electrolytic oxidant producing unit together with another salt, such as a chloride salt.

Referring now to FIG. 5, a simplified flow diagram of a process for contacting a mixed oxidant with a treatment fluid according to embodiments disclosed herein is illustrated, where like numerals represent like parts. In this embodiment, hypobromous acid may be generated by feeding a salt solution 40, such as a chloride salt, to the electrolytic oxidant producing unit 42. The oxidant solution produced by the electrolytic oxidant producing unit 42 may be combined with a bromide salt solution 45 to generate hypobromous acid. For example, hypochlorous acid produced by electrolysis of a chloride salt solution, such as sodium chloride, may be combined with a bromide salt solution, such as sodium bromide or potassium bromide, downstream from the electrolytic cell. The hypochlorous acid oxidant reacts with free bromide ions in solution formed during dissolution of the bromide salt to produce hypobromous acid and chloride ions. For example, the mixed oxidant and bromide salt solutions may be combined by mixing of streams 44, 45 at a mixing point 47 or by adding the bromide salt to a reaction vessel, such as storage vessel 46, via line 49. The bromide salt solution may be mixed on-site by admixing the salt and water or transported already pre-mixed. Similar to the formation of a saturated salt solution in tank 34, a bromide salt may be loaded into a tank 54, on site or at a remote site prior to transport to the site, and contacted with water to form a bromide salt solution. Optionally, the premixed bromide salt solution may be further diluted with an aqueous solution before being combined with the oxidant.

Mixed oxidants produced using chlorine salts, as noted above, may contain various chemical species, including hypochlorous acid, hypochlorite, and others. Contact with bromide salts may be at a ratio so as to provide sufficient bromine content to react with some or all of the hypochlorous acid, the content of which in the mixed oxidant solution may depend upon numerous factors, including electrolytic cell type and performance, among others. Use of excess bromide salt may be undesirable, as bromide salts are generally more expensive than chlorine salts. In some embodiments, a bromide salt solution and a mixed oxidant solution formed from a chlorine salt solution may be admixed in respective proportions to provide a bromine to chlorine ratio in the range from about 1:50 to about 1:1; in the range from about 1:20 to about 1:2 in other embodiments; and in the range from about 1:5 to about 1:15, such as about 1:10, in yet other embodiments.

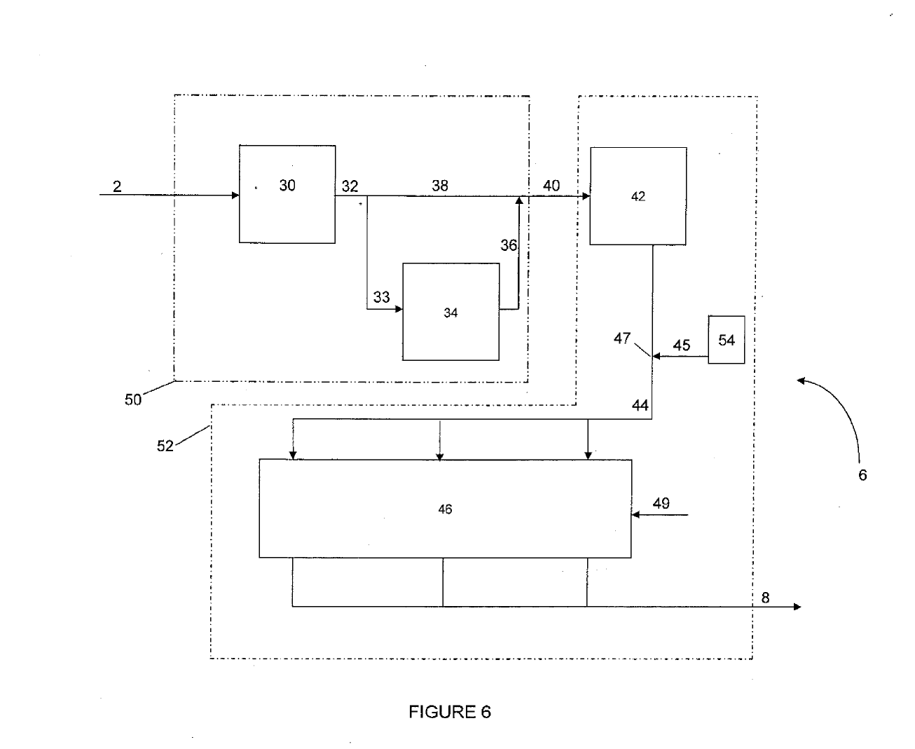

As noted above, the transportable systems disclosed herein may be delivered to wellsites having varying degrees of communication or ability to interface with the control systems used in embodiments herein. As such, the control systems must be flexible to meet the environment encountered at the wellsite. Similarly, transportable systems disclosed herein may encounter wellsites having various types of water, frac water, chemical additives, etc., that may affect the performance of systems disclosed herein. Accordingly, systems as illustrated in FIG. 6, including a bromide salt addition system may provide for flexibility between drill sites and their varying conditions. One wellsite may require use of bromide salts, possibly due to ammonia, sulfides, oxidizable iron, manganese, or other oxidant consuming species in the frac water/treatment fluid, and the next wellsite may not require use of bromide salts. Thus, embodiments disclosed herein may include use of analytical or other techniques to determine if use of bromide salts is necessary (e.g., measuring treatment fluid water quality, communicating with wellsite to determine types of chemicals added, etc.).

Another embodiment of the method may comprise forming a treatment fluid from an ammonia containing water source by adding hypobromous acid to disinfect the water. As mentioned, other oxidants, such as hypochlorous acid, may not be as effective as hypobromous acid to disinfect a treatment fluid in the presence of ammonia. Ammonia is often found in flow-back water from fracturing operations. By using hypobromous acid as a disinfectant, fracturing flow-back water may be recycled for re-use during the same or in a subsequent fracturing operation.

Some formations or water sources already contain bromide salts that may be used to generate the hypobromous acid. For example, flow-back waters from fracturing operation in some locations in the U.S. state of Arkansas contain bromide salts. Thus, in some embodiments, the treatment fluid may be disinfected by admixing an oxidant, like hypochlorous acid generated by electrolysis as disclosed herein, with the bromide salt-containing water to produce the hypobromous acid with the already existing bromide salt. Thereby, the need to transport bromide salt to the site of disinfection operation may be reduced or eliminated.

As described above, a system for generating a mixed oxidant useful for disinfecting a treatment fluid is provided. Advantageously, the system may provide for virtually chemical-free sterilization, using a mixed oxidant that has low or no toxicity, a short half life, and which degrades rapidly to naturally occurring chemicals following use or contact with the downhole formation. Thus, the disinfecting process provided by systems disclosed herein may have no or minimal environmental impact. The system is robust, may tolerate the harsh conditions of a well site, including dusting and other environmental conditions, and may use available surface water, thus minimizing the impact on the potable water supply at the well site.

In some embodiments, the system for generating a mixed oxidant may be containerized and transportable. Advantageously, this system may have a small footprint, may be transported to the well site only when needed, and may be set up and removed from a drill site rapidly. Further, pre-loading of chemicals in storage tanks before transport of the system to a well site may minimize or eliminate the need for chemical delivery and handling at the well site.

Overall, embodiments of the processes and systems disclosed herein may have one or more of the following advantages:
The treatment may be used for all fresh or recycled water (flow back, produced, water from drilling fluids, in frac tanks, water produced during air drilling, stagnant ponds, etc.), water and steam injection (enhanced recovery), packer fluids, oilfield pipelines, disposal wells, workovers, production (replace biocides, remove slime), and other applications in the downstream areas.
The treatment is non-damaging to frac fluids.
The treatment is non-damaging to the wellbore, pumps, pipelines, etc.
The treatment is effective under all foreseeable conditions; pH, temperature, pressure, etc.
The treatment will oxidize and reduce other harmful components in the fluid:
   Organics forming food for bacteria and help prevent re-growth.
   H2S, iron and possibly some other inorganics.
The treatment can remove slime.
The residual may be sufficient to prevent re-growth in the wellbore and effectively reduce the bacteria in the flow-back fluid.
The equipment is responsive to changing water properties.
The equipment may have single well autonomy, able to treat a frac without re-supply (except for diesel fuel).
The equipment may be mobile—able to go to any frac site or other application.
The process may have complete redundancy—back-up power supply, control system and pumps, back-up disinfectant, etc.
The process may significantly reduce the carbon footprint and improve HSE over existing processes.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All priority documents are herein fully incorporated by reference for all jurisdictions in which such incorporation is permitted and to the extent such disclosure is consistent with the description of the present invention. Further, all documents and references cited herein, including testing procedures, publications, patents, journal articles, etc. are herein fully incorporated by reference for all jurisdictions in which such incorporation is permitted and to the extent such disclosure is consistent with the description of the present invention.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

As described above, systems and processes disclosed herein may provide for one or more of the following embodiments, among others:
1. A process for disinfecting a treatment fluid, comprising:
   admixing an aqueous solution comprising two or more oxidants generated via electrolysis of a salt solution with a treatment fluid.
2. The process of embodiment 1, admixing one or more salts and water to form the salt solution.
3. The process of embodiment 1 or embodiment 2, wherein the one or more salts comprise at least one of an alkali metal halide, an alkaline earth metal halide, and a transition metal halide.
4. The process of any one of embodiments 1-3, further comprising converting the salt solution to an aqueous solution comprising the two or more oxidants via electrolysis.
5. The process of any one of embodiments 1-4, wherein the two or more mixed oxidants comprise two or more of ozone, hydrogen peroxide, hypochlorite, hypochlorous acid, chlorine dioxide, hypobromous acid, bromine, and chlorine.
6. The process of any one of embodiments 1-5, further comprising contacting the treatment fluid with the two or more oxidants for a time in the range from 1 second to 2 hours.
7. The process of any one of embodiments 1-6, further comprising measuring at least one of a residual oxidant content, a pH, a free available halogen content, and an oxidation reduction potential.
8. The process of any one of embodiments 7, further comprising adjusting at least one of a volumetric ratio of the aqueous solution to the treatment fluid and a contact time based upon the measured at least one of a residual oxidant content, a pH, a free available halogen content, and an oxidation reduction potential.
9. The process of any one of embodiments 2-8, further comprising treating the water prior to the admixing the water with the one or more salts.
10. The process of embodiment 9, wherein the treating comprises at least one of filtering, softening, heating, and cooling.
11. A method of servicing a wellbore, comprising:
   transporting a portable tank containing a quantity of one or more salts to a well site to be serviced;
   generating a salt solution by passing water through the portable tank to dissolve a portion of the salt;
   converting the salt solution to an aqueous solution comprising one or more oxidants via electrolysis;
   contacting the aqueous solution with a treatment fluid to form a treated treatment fluid; and
   placing the treated treatment fluid into the wellbore.
12. The process of embodiment 11, wherein the salt comprises at least one of an alkali metal halide, an alkaline earth metal halide, and a transition metal halide.
13. The process of embodiment 11 or embodiment 12, wherein the one or more oxidants comprise one or more of ozone, hydrogen peroxide, hypochlorite, hypochlorous acid, chlorine dioxide, hypobromous acid, bromine, and chlorine.
14. The process of any one of embodiments 11-13, wherein the converting step comprises:
   admixing the generated salt solution with additional water to produce a diluted salt solution;
   electrolyzing the diluted salt solution to form the aqueous solution.
15. The process of embodiments 14, wherein the diluted salt solution contains from 0.01% to 5% by weight dissolved salts.
16. The process of any one of embodiments 11-15, wherein the contacting step comprises contacting the treatment fluid with the two or more oxidants for a time in the range from 1 second to 2 hours before placing the treated treatment fluid into the wellbore.
17. The process of any one of embodiments 11-16, further comprising measuring at least one of a residual oxidant content, a pH, a free available halogen content, and an oxidation reduction potential of the treated treatment fluid.
18. The process of any one of embodiment 17, further comprising adjusting at least one of a volumetric ratio of the aqueous solution to the treatment fluid and a contact time based upon the measured at least one of a residual oxidant content, a pH, a free available halogen content, and an oxidation reduction potential.
19. The process of any one of embodiments 11-18, further comprising treating the water prior to the use of the water in at least one of the generating step and the converting step.
20. The process of embodiment 19, wherein the treating comprises at least one of filtering, softening, heating, and cooling.
21. A portable system for disinfecting water, comprising:
   (a) a fluid connection for connecting to a water supply;
   (b) a treatment system for conditioning the water supplied;
   (c) a tank for admixing at least a portion of the conditioned water with one or more salts to form a salt solution;
   (d) at least one electrolytic oxidant producing unit for converting at least a portion of the salt solution to an aqueous solution comprising mixed oxidants;
   (e) one or more tanks for storing the aqueous solution; and
   (f) a fluid connection for transporting the aqueous solution from the one or more tanks for storing for contact with a fluid to be disinfected.
22. The system of embodiment 21, further comprising at least one of:
   (g) an acid supply tank for supplying acid to periodically clean the at least one electrolytic oxidant producing unit;
   (h) a sampling system for sampling the fluid following contact with the aqueous solution;
   (i) a process returns tank for accumulating materials from one or more of the treatment system, the tank for admixing, the electrolytic oxidant producing unit(s), the one or more tanks for storing, the acid supply tank, the sampling system; and piping, pumps, and equipment associated therewith;
   (j) a fluid connection for transporting accumulated materials from the process returns tank;
   (k) one or more fluid conduits for transporting treated fluid to the sampling system;
   (l) a control system for controlling a feed rate of the aqueous solution.
23. The system of embodiment 21 or embodiment 22, wherein the treatment system for conditioning the water comprises at least one of:
   (i) a filter for reducing a solids content of the water;
   (ii) a water softening system for reducing a metals content of the water; and
   (iii) a heat exchanged for adjusting a temperature of the water.
24. The system of any one of embodiments 21-23, wherein the at least one electrolytic oxidant producing unit is in an enclosure having a filtered air cooling system.
25. The system of any one of embodiments 21-24, wherein the system is modular.
26. The system of embodiment 25, comprising a first module and a second module,
   the first module containing components (a), (b), and (c);
   the second module containing components (d), (e), and (f).
27. The system of embodiment 26, wherein the first module further contains at least one of components (h), (i), (j), and (k).
28. The system of embodiments 26 or 27, wherein the first module is containerized and is no greater in size than one twenty-foot equivalent unit (TEU) (container 20 feet long by 8 feet wide by 9.5 feet tall) (6.1 m×2.4 m×2.9 m) (1520 cu ft or 43 m³).
29. The system of any one of embodiments 26-28, wherein the second module further contains at least one of components (g) and (l).
30. The system of any one of embodiments 26-29, wherein the second module is containerized and is no greater in size than one forty-foot equivalent unit (FEU) (container 40 feet long by 8 feet wide by 9.5 feet tall) (12.2 m×2.4 m×2.9 m) (3040 cu ft or 87 m³).
31. The modular system of embodiment 30, wherein the one or more tanks for storing the aqueous solution (e) comprises at least two tanks each having a volume of at least 500 gallons.
32. The system of any one of embodiments 22-31, further comprising one or more communication conduits for sending or receiving a signal with the control system from a local or remote source, where the signal may be used to monitor or control the system and/or may provide an indication of at least one of:
   an indication of when to start or stop feeding the aqueous solution, such as to avoid mixing of the aqueous solution during an acid spear, commonly used at the beginning of a fracturing operation;
   at least one of a residual oxidant content, a pH, a free available halogen content, and an oxidation reduction potential of the treated fluid;
   a flow rate of at least one of the fluid to be disinfected, a treatment fluid precursor, and the treated fluid; and
   a property of at least one of the fluid to be disinfected, a treatment fluid precursor, and the treated fluid after contact of the aqueous solution with the fluid to be disinfected, for example, a composition of the treatment fluid, such as a treatment fluid additive amount or type.
33. The system of embodiment 32, wherein the control system is configured to control the feed rate of the aqueous solution both in the presence of and absence of receiving the signal with the control system from the remote source.
34. A method of disinfecting a fluid, comprising:
   disposing a quantity of one or more salts in a tank;
   receiving water from a water supply;
   treating the water received in a water treatment system to form a conditioned water stream;
   generating a salt solution by passing a first portion of the conditioned water through the tank to dissolve a portion of the one or more salts;
   combining the salt solution with a second portion of the conditioned water to form a diluted salt solution;
   feeding the diluted salt solution to one or more electrolytic oxidant producing units to convert the salt solution to an aqueous solution comprising one or more oxidants via electrolysis;
   contacting the aqueous solution with a fluid to for n a treated fluid.
35. The process of embodiment 34, further comprising sampling the treated fluid using a sampling system and measuring at least one of a residual oxidant content, a pH, a free available halogen content, and an oxidation reduction potential of the treated fluid.
36. The process of embodiment 34 or embodiment 35, wherein the treating comprises at least one of filtering, softening, heating, and cooling.
37. The process of any one of embodiments 34-36, further comprising cleaning or purging at least one of the tank, the electrolytic oxidant producing unit(s), the sampling system, and the water treatment system using at least one of the water received, a third portion of the conditioned water, the salt solution, and an acid.
38. The process of embodiment 37, further comprising accumulating a process returns stream from the cleaning or purging.
39. The process of embodiment 38, wherein the fluid is a treatment fluid, the process further comprising using at least a portion of the process returns stream to form at least a portion of the treatment fluid.
40. The process of embodiment 39, further comprising placing the treated treatment fluid into a wellbore.
41. The process of any one of embodiments 34-40, further comprising transporting the tank containing the disposed quantity of one or more salts to a well site to be serviced.
42. A method of fracturing a subterranean formation comprising:
   disposing a quantity of one or more salts in a tank;
   receiving water from a water supply;
   treating the water received in a water treatment system to form a conditioned water stream;
   generating a salt solution by passing a first portion of the conditioned water through the tank to dissolve a portion of the one or more salts;
   combining the salt solution with a second portion of the conditioned water to form a diluted salt solution;
   feeding the diluted salt solution to one or more electrolytic oxidant producing units to convert the salt solution to an aqueous solution comprising one or more oxidants via electrolysis;
   contacting the aqueous solution with a fluid to form a treated fluid; and
   using at least a portion of the treated fluid in a fracturing operation.
43. The process of embodiment 42, further comprising transporting the tank containing the disposed quantity of one or more salts to a well site to be serviced.
44. A method of servicing a wellbore, comprising:
   contacting a treatment fluid or treatment fluid precursor with an aqueous solution comprising one or more oxidants produced via electrolysis of a salt solution to form a treated fluid;
   placing the treated fluid in the wellbore.
45. The method of embodiment 44, wherein the treatment fluid is a fracturing fluid used in a fracturing operation.
46. The method of embodiment 44 or embodiment 45, further comprising measuring at least one of a residual oxidant content, a pH, a free available halogen content, and an oxidation reduction potential of the treated fluid.
47. The method of embodiment 46, further comprising adjusting a rate of the aqueous solution provided for the contacting based upon at least one of:
   the measured at least one of a residual oxidant content, a pH, a free available halogen content, and an oxidation reduction potential of the treated fluid;
   a flow rate of at least one of the treatment fluid, the treatment fluid precursor, and the treated fluid; and
   a measured property of the treatment fluid or treatment fluid precursor fed to the contacting.
48. The method of any one of embodiments 44-47, further comprising forming a salt solution and converting the salt solution via electrolysis to form the aqueous solution.
49. The method of embodiment 48, further comprising storing a quantity of one or more of the salt solution and the aqueous solution in a storage vessel.
50. The method of embodiment 49, further comprising controlling one or more of the electrolysis, the forming a salt solution, the converting the salt solution, the storing, the adjusting, and the measuring using a control system.
51. The method of embodiment 50, further comprising receiving a signal with the control system from a local or remote source, where the signal provides an indication of at least one of:
   the measured at least one of a residual oxidant content, a pH, a free available halogen content, and an oxidation reduction potential of the treated fluid;
   a flow rate of at least one of the treatment fluid, the treatment fluid precursor, and the treated fluid; and
   a measured property of the treatment fluid or treatment fluid precursor fed to the contacting.
52. The method of embodiment 51, wherein the control system is configured to control the one or more of the electrolysis, the forming a salt solution, the converting the salt solution, the storing, the adjusting, and the measuring both in the presence of and absence of receiving the signal with the control system from the remote source.
53. A method for disinfecting a treatment fluid, comprising:
   admixing an aqueous solution comprising hypobromous acid generated from a bromide salt solution with a treatment fluid.
54. The method of embodiment 53, wherein the hypobormous acid is generated by a method comprising: feed the bromide salt solution to an electrolytic cell.
55. The method of embodiment 53, wherein the hypobromous acid is generated by a method comprising:
   feeding a chloride salt solution to an electrolytic cell to form an oxidant solution comprising hypochlorous acid; and
   admixing the oxidant solution to the bromide salt solution.
56. The method of embodiment 53, where the hypobromous acid is generated by a method comprising:
   feeding the bromide salt solution and a chloride salt solution to an electrolytic cell.
57. The method of any one of embodiments 53-56, comprising admixing at least one bromide salt and water to form the bromide salt solution.
58. A method for forming a treatment fluid using an ammonia-containing water source, the method comprising:
   admixing an aqueous solution comprising hypobromous acid generated from a bromide salt solution to the ammonia-containing water.
59. A method for recycling flow-back water from a fracturing operation comprising:
   admixing an aqueous solution comprising hypobromous acid generated from a bromide salt solution with the flow-back water; and
   re-using the flow-back water in a fracturing operation.
60. A method recycling flow-back water from a fracturing operation comprising:
   storing the flow-back water containing ammonia and a bromide salt in a tank or pond;
   admixing the flow-back water with an oxidant solution generated by on-site electrolysis of a chloride salt solution; and
   re-using the flow back water in a fracturing operation.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed:

1. A process for disinfecting a treatment fluid, comprising:
admixing an aqueous solution comprising two or more oxidants generated via electrolysis of a salt solution with a treatment fluid or treatment fluid precursor.

2. The process of claim 1, further comprising at least one of:
disposing a quantity of one or more salts in a tank;
transporting the tank containing the disposed quantity of one or more salts to a well site to be serviced;
receiving water from a water supply;
treating the water received in a water treatment system to form a conditioned water stream, wherein the treating comprises at least one of filtering, softening, heating, and cooling;
admixing the one or more salts and the water to form the salt solution, wherein the water may be a first portion of the conditioned water stream;
combining the salt solution with additional water to form a diluted salt solution, wherein the additional water may be a second portion of the conditioned water stream;
converting the salt solution to an aqueous solution comprising the two or more oxidants via electrolysis in one or more electrolytic oxidant producing units.

3. The process of claim 1 or claim 2, wherein the one or more salts comprise at least one of an alkali metal halide, an alkaline earth metal halide, and a transition metal halide, and wherein the two or more mixed oxidants comprise two or more of ozone, hydrogen peroxide, hypochlorite, hypochlorous acid, chlorine dioxide, hypobromous acid, bromine, and chlorine.

4. The process of any one of claims 1-3, further comprising measuring at least one of a residual oxidant content, a pH, a free available halogen content, and an oxidation reduction potential, and adjusting at least one of a volumetric ratio of the aqueous solution to the treatment fluid and a contact time based upon the measured at least one of a residual oxidant content, a pH, a free available halogen content, and an oxidation reduction potential.

5. The method of any one of claims 1-4, further comprising at least one of:
storing a quantity of one or more of the salt solution, diluted salt solution, and the aqueous solution in a storage vessel;
cleaning or purging at least one of the tank, the electrolytic oxidant producing unit(s), the sampling system, and the water treatment system using at least one of the water received, a third portion of the conditioned water, the salt solution, and an acid; and
accumulating materials from the cleaning or purging in a process returns tank; and
using at least a portion of the materials from the cleaning or purging to form at least a portion of the treatment fluid;
providing the treated treatment fluid for placement into a wellbore; and
using at least a portion of the treated fluid in a fracturing operation.

6. The method of any one of claims 1-5, further comprising controlling one or more of the electrolysis, the forming a salt solution, the converting the salt solution, the storing, the adjusting, and the measuring using a control system.

7. The method of claim 6, wherein the control system is configured for receiving a signal from and/or sending a signal to a local or a remote source.

8. The method of claim 7, wherein the control system is configured to determine a feed rate of the aqueous solution, adjust a feed rate of the aqueous solution, and/or control the feed rate of the aqueous solution, both in the presence of and absence of receiving or sending the signal with the control system from or to the remote source.

9. The method of claim 6 or claim 7, the process further comprising at least one of:
receiving a signal to adjust a system input or output from the remote source;
transmitting process data to a remote source monitoring the disinfecting process;
receiving a signal indicating at least one of a residual oxidant content, a pH, a free available halogen content, and an oxidation reduction potential of the treated fluid;
receiving a signal indicating a flow rate and/or composition of at least one of the fluid to be disinfected, a treatment fluid precursor, and the treated fluid; and
receiving a signal indicating a property of at least one of the fluid to be disinfected, a treatment fluid precursor, and the treated fluid after contact of the aqueous solution with the fluid to be disinfected;
determining with the control system an aqueous solution flow rate using feedforward and/or feedback control based upon the signals received; and
generating and/or sending a treatment report.

10. The method of any one of claims 1-9, wherein the aqueous solution comprises hypobromous acid formed by at least one of:
electrolysis of a salt solution comprising a bromide salt;
electrolysis of a salt solution comprising a chloride salt and a bromide salt; and
admixing an aqueous solution comprising hypochlorous acid, formed by electrolysis of a salt solution comprising a chloride salt, with a salt solution comprising a bromide salt.

11. A method of servicing a wellbore, comprising:
transporting a portable tank containing a quantity of one or more salts to a well site to be serviced;
generating a salt solution by passing water through the portable tank to dissolve a portion of the salt;
converting the salt solution to an aqueous solution comprising one or more oxidants via electrolysis;
contacting the aqueous solution with a treatment fluid to form a treated treatment fluid; and
providing the treated treatment fluid for placement into the wellbore.

12. The process of claim 11, wherein the salt comprises at least one of an alkali metal halide, an alkaline earth metal halide, and a transition metal halide, and wherein the one or more oxidants comprise one or more of ozone, hydrogen peroxide, hypochlorite, hypochlorous acid, chlorine dioxide, hypobromous acid, bromine, and chlorine.

13. The process of any one of claims 9-12, wherein the converting step comprises:
admixing the generated salt solution with additional water to produce a diluted salt solution;
electrolyzing the diluted salt solution to form the aqueous solution.

14. The process of any one of claims 9-13, further comprising measuring at least one of a residual oxidant content, a pH, a free available halogen content, and an oxidation reduction potential of the treated treatment fluid, and adjusting at least one of a volumetric ratio of the aqueous solution to the treatment fluid and a contact time based upon the measured at least one of a residual oxidant content, a pH, a free available halogen content, and an oxidation reduction potential.

15. The process of any one of claims 9-14, further comprising treating the water prior to the use of the water in at least one of the generating step and the converting step, wherein the treating comprises at least one of filtering, softening, heating, and cooling.

16. A portable system for disinfecting water, comprising:
(a) a fluid connection for connecting to a water supply;
(b) a treatment system for conditioning the water supplied;
(c) a tank for admixing at least a portion of the conditioned water with one or more salts to form a salt solution;
(d) at least one electrolytic oxidant producing unit for converting at least a portion of the salt solution to an aqueous solution comprising mixed oxidants;
(e) a fluid connection for transporting the aqueous solution for contact with a fluid to be disinfected.

17. The system of claim 16, further comprising at least one of:
(f) one or more tanks for storing the aqueous solution;
(g) an acid supply tank for supplying acid to periodically clean the at least one electrolytic oxidant producing unit;
(h) a sampling system for sampling the fluid following contact with the aqueous solution;
(i) a process returns tank for accumulating materials fed from one or more of the treatment system, the tank for admixing, the electrolytic oxidant producing unit(s), the one or more tanks for storing, the acid supply tank, the sampling system; and piping, pumps, and equipment associated therewith;
(j) a fluid connection for transporting accumulated materials from the process returns tank;
(k) one or more fluid conduits for transporting treated fluid to the sampling system;
(l) a control system for controlling a feed rate of the aqueous solution.

18. The system of claim 16 or claim 17, wherein the treatment system for conditioning the water comprises at least one of:
(i) a filter for reducing a solids content of the water;
(ii) a water softening system for reducing a metals content of the water; and
(iii) a heat exchanger for adjusting a temperature of the water.

19. The system of any one of claims 16-18, wherein the at least one electrolytic oxidant producing unit is in an enclosure having a filtered air cooling system.

20. The system of any one of claims 16-19, wherein the system is modular.

21. The system of any one of claims 16-20, further comprising one or more communication conduits for receiving a signal with or sending a signal from the control system from or to a local or remote source.

22. The system of claim 21, wherein the signal provides at least one of:
control system inputs or outputs for remote monitoring or operational control;
at least one of a residual oxidant content, a pH, a free available halogen content, and an oxidation reduction potential of the treated fluid;
a flow rate of at least one of the fluid to be disinfected, a treatment fluid precursor, and the treated fluid; and
a property of at least one of the fluid to be disinfected, a treatment fluid precursor, and the treated fluid after contact of the aqueous solution with the fluid to be disinfected.

23. The system of claim 21 or claim 22, wherein the control system is configured to determine a feed rate of the aqueous solution, adjust a feed rate of the aqueous solution, and/or control the feed rate of the aqueous solution, both in the presence of and absence of receiving or sending the signal with the control system from or to the remote source.

24. The system of claim 23, wherein the control system is configured for at least one of:
receiving a signal to adjust a system input or output from the remote source;
transmitting process data to a remote source monitoring the disinfecting process;
receiving a signal indicating at least one of a residual oxidant content, a pH, a free available halogen content, and an oxidation reduction potential of the treated fluid;
receiving a signal indicating a flow rate and/or composition of at least one of the fluid to be disinfected, a treatment fluid precursor, and the treated fluid;
receiving a signal indicating a property of at least one of the fluid to be disinfected, a treatment fluid precursor, and the treated fluid after contact of the aqueous solution with the fluid to be disinfected;
determining with the control system an aqueous solution flow rate using feedforward and/or feedback control based upon the signals received; and
generating and/or sending a treatment report.
